(19) United States
(12) Patent Application Publication
(10) Pub. No.: US 2003/0031335 A1
(43) Pub. Date: Feb. 13, 2003

(54) Method for processing an input signal to generate an output signal, and application of said method in hearing aids and listening devices

(76) Inventor: Hans-Ueli Roeck, Hombrechtikon (CH)

Correspondence Address: PEARNE & GORDON LLP, 526 SUPERIOR AVENUE EAST, SUITE 1200, CLEVELAND, OH, 44114-1484, US

(21) Appl. No.: 09/924,753

(22) Filed: Aug. 8, 2001

(51) Int. Cl. H04R 25/00

(52) U.S. Cl. 381/317

(57) ABSTRACT

Here described are a method and a system for defining a threshold value (Oₘₐₓ, Oₘᵢₙ, O_{TR}) serving to limit the output signal of a processing unit which is fed an input signal. According to the invention, an input-signal level is determined and the threshold value (Oₘₐₓ, Oₘᵢₙ, O_{TR}) is set as a function of that input-signal level. By virtue of the fact that the threshold value is set as a function of the input-signal level, i.e. in adaptive fashion, it is also possible to limit transient noise whose level is well below the maximum value of the threshold value. As a result, when the method or system per this invention is applied in a hearing aid, the hearing comfort of the wearer of the hearing aid can be significantly enhanced.

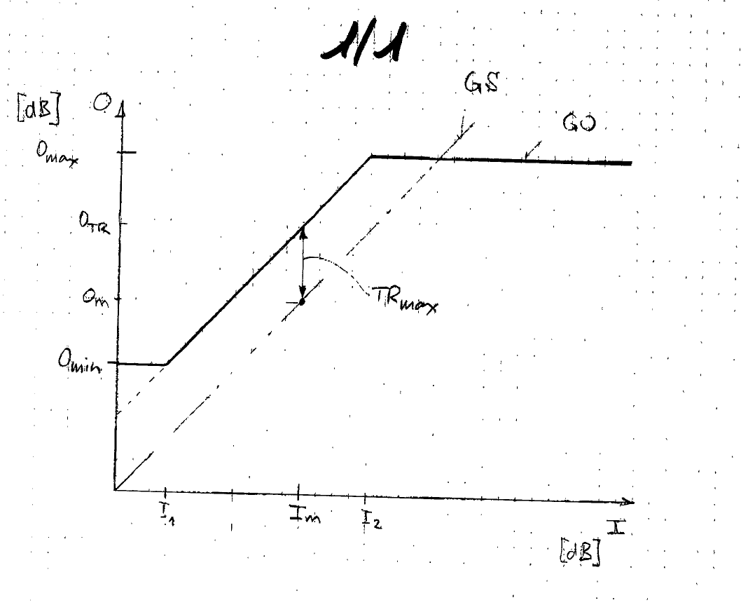

This invention relates to a method for processing an input signal to generate an output signal, and to applications of that method in hearing aids and listening devices.

So-called transient limiters are signal processing units which are capable, without any delay or overshoot, of limiting rapidly ramping, short-duration i.e. transient signal components to a predefined level, hereinafter referred to as the threshold value. The threshold value concerned, at which the transient limiter performs its function, is not signal-dependent but can instead be set as a parameter.

Transient limiters are employed for instance in hearing aids which serve to compensate for a patient's hearing impairment, but also in auditory amplification systems which are used for enhancing audibility in special situations such as listening and monitoring operations. In the following description the term “hearing aid” is to be understood as comprehensively referring to the medical hearing aids and to the listening devices mentioned above. Where any of the following elucidations relate uniquely to applications in listening devices, they will be explicitly identified as such.

In hearing aids, transient limiters serve the purpose of preventing the maximum output level in the hearing aid from exceeding a predefined threshold value. This protects the user of the hearing aid from excessive noise exposure.

It is a known fact that human speech occupies a dynamic range of about −15 to +18 dB (decibels) around the respective mean level; in quiet surroundings with little ambient noise, that mean level is about 60 to 65 dB. In loud surroundings the mean level can rise to about 80 dB or higher. Given these facts, the conventional methods for limiting the audio signal components for persons with normal hearing have employed fixed maximum values of 100 to 120 dB. In cases of diminished hearing capacity the threshold value is suitably set at a comfortable maximum level below the threshold of pain for the patient or user.

It is a characteristic aspect of human auditory perception that not only sounds above the maximum threshold value or comfort level are bothersome. Indeed, it is also transient sounds (such as intermittent noise), even when at a level distinctly below the maximum threshold value, that are perceived as unpleasant in an otherwise prevalently quiet environment. For example, in quiet surroundings, the transient noise of dishes and cutlery, even if well below the maximum threshold value of 100 to 120 dB, creates an unpleasant auditory sensation.

It is therefore the objective of this invention to introduce a method by which the aforementioned problems are avoided.

This objective is achieved by means of the measures specified in the characterizing part of claim 1. Additional claims cover advantageous implementational variations of this invention as well as various applications of said method.

By setting the threshold value as a function of the level of the input signal, i.e. adaptively, it is possible to limit even transient noise whose level is well below the maximum threshold value, thus permitting a significantly greater hearing comfort for the wearer of the hearing aid.

The following explains this invention in more detail with the aid of a diagrammatic example in which the single figure depicts the pattern of an effective threshold value, selected according to the invention as a function of a given level of the input signal.

The method per this invention and its various applications are explained based on the pattern of a threshold value shown in the diagram and adjusted as a function of a given input signal I. This is with initial reference to a person with normal hearing.

In the FIGURE, GO represents the curve of the threshold value set per this invention and indicated by a solid line. GS represents the median curve of the level of an input signal, indicated by a dash-dotted line.

The method per this invention continuously determines a threshold value O which, when necessary i.e. when the level of the input signal is too high, serves as the limiting parameter. To that effect the respective momentary threshold value O is a function of the level I of the input signal. It follows that the threshold value which serves to limit the level of the input signal is continuously adapted to the varying, momentarily prevailing auditory conditions; in other words, the threshold value is adjusted in adaptive fashion.

The threshold value O can be set by first defining a momentary mean level I of the input signal. This may be accomplished for instance by the following approach:

$$I = \frac{I}{T} \times {\int }_{o}^{T} \vert s ( t ) \vert \times ⅆ t$$

Calculated along this formula is a time-based mean value I across the magnitude of the input signal s(t), with the averaging performed over a time interval T which may be a time span of for instance 5 seconds. The formula shown can be applied directly to analog systems. From it, the expert can easily derive a corresponding formula for digital systems.

In another implementational variation of the method per this invention the average or mean level I of the input signal s(t) can be determined strictly on the basis of ambient noise without factoring in any voice signals of interest.

To avoid clipping any voice or speech signals the invention further proposes to set the momentary threshold value O at a point higher by a differential amount TRₘₐₓ than the mean level I. The momentary threshold value is preferably set twenty decibels (dB) above that mean or average level I so that, given the aforementioned dynamic range of voice signals which straddles the mean level from about −15 dB to +18 dB, any voice limitation is prevented.

In the diagram, Iₘ represents a mean level of the input signal, calculated by the formula shown above. Based on the value for the level Iₘ a threshold value O_{TR} is set which can be determined by adding a mean output signal Oₘ to the differential amount TRₘₐₓ. The determination per this invention of the momentary threshold value O_{TR} provides significantly greater hearing comfort for the wearer of the hearing aid for as long as the mean level I remains within an interval of I₁ to I₂. If a mean level I of the input signal were to be set at above the level I₂ and the method per this invention as described thus far is applied, the resulting level of the output signal would be above the threshold of pain. Conversely, if the mean level I of the input signal were to be set at below the level I₁ and the method per this invention as described thus far is applied, it would pose the risk of at least the first few spoken syllables being clipped, i.e. limited, before the mean level I regains higher values.

Therefore, to prevent the effective threshold value O from rising too high in the case of noisy surroundings, another form of implementation of the method per this invention provides for the establishment of a maximum threshold value Oₘₐₓ, that value preferably being 120 dB. In the diagram this is expressed by a horizontal progression of the curve GO of the threshold value at Oₘₐₓ.

Further to the above, another form of implementation of this method provides for the setting of a minimum threshold value Oₘᵢₙ, for the following reason: In quiet surroundings the mean level I quickly drops to values below 45 dB. That would swallow up, i.e. limit, at least any first spoken syllable before the mean level I has returned to 60 dB. This can be avoided by setting a minimum threshold value Oₘᵢₙ, preferably at 80 dB, which then constitutes the lowest acceptable level. The diagram again shows a horizontal progression of the curve GO of the threshold value at Oₘᵢₙ.

As was pointed out further above, the description so far given is based on the application of the method per this invention in the hearing aid i.e. listening device for a person with normal hearing. Where the method per this invention is applied in the hearing aid of a hearing-impaired person, a corresponding adaptation of the numerical parameters is necessary.

The following implementation examples of the method per this invention are specifically aimed at listening device-type hearing aids:

The minimum threshold value Oₘᵢₙ is amplified by a gain factor averaged over the applicable range. At the same time the maximum value Oₘₐₓ for the threshold value O is adjusted to the upper comfort level (UCL) of the person concerned. In addition, the differential amount TRₘₐₓ is adjusted to a user-specific compression ratio. In comprehensive terms the parameters involved, these being the minimum threshold value Oₘᵢₙ, the maximum value Oₘₐₓ for the threshold value O and the differential amount TRₘₐₓ, are converted into output-specific values. Depending on the fitting function employed, this involves an input-level-dependent amplification of the values Oₘᵢₙ and Oₘₐₓ max and a corresponding compression factor for TRₘₐₓ. Typical compression factors range from 1 (one), meaning no compression, to four (4).

Another form of implementation provides for a soft or a hard limitation of the input signals. In the case of a hard limitation the output signal, with the correct sign, is limited to the respective level of the threshold value not until that is about to be exceeded. The limit can be viewed as a compression factor of infinite magnitude. In the case of a soft limitation an increasingly larger compression factor is applied even before the threshold value is reached. The concomitant distortion causes any harmonics to weaken, the signal form to look “rounder” and the signal thus limited to have a more pleasant sound.

1. Method for determining a threshold value (Oₘₐₓ, Oₘᵢₙ, O_{TR}) serving to limit the output signal of a processing unit into which an input signal has been fed, characterized in that the level of the input signal is determined and that the threshold value (Oₘₐₓ, Oₘᵢₙ, O_{TR}) is set as a function of that level of the input signal.

2. Method as in claim 1, characterized in that from the said level a mean level (I) is derived on the basis of which the threshold value (Oₘₐₓ, Oₘᵢₙ, O_{TR}) is set, with preferably only ambient noise contained in the input signal being factored in.

3. Method as in claim 2, characterized in that the threshold value (O_{TR}) is set by a differential amount (TRₘₐₓ) above the mean level (I) of the input signal, said differential amount (TRₘₐₓ) preferably being equal to twenty decibels.

4. Method as in claim 2, characterized in that the mean level (I) is derived from the input signal s(t) along the following formula:
$$I = \frac{I}{T} \times {\int }_{o}^{T} \vert s ( t ) \vert \times ⅆ t$$
whereby an averaging function is performed over a time interval T having a duration of preferably five seconds.

5. Method as in one of the claims 1 to 4, characterized in that a maximum threshold value (Oₘₐₓ) is established.

6. Method as in claim 5, characterized in that the maximum threshold value (Oₘₐₓ) is so selected as to be equal to an upper comfort level of a hearing-impaired person.

7. Method as in one of the claims 1 to 6, characterized in that a minimum threshold value (Oₘᵢₙ) is established.

8. Method as in claim 7, characterized in that the minimum threshold value (Oₘᵢₙ) is so selected as to be equal to an output level that results from an input level of preferably 80 dB and the corresponding amplification at that input level that is produced for a hearing-impaired person.

9. Method as in one of the claims 2 to 8, characterized in that the differential amount (TRₘₐₓ) is adjusted along a compression ratio for a hearing-impaired person.

10. Application of the method per one of the claims 1 to 9 for operating a hearing aid.

11. Application of the method per one of the claims 6, 8 or 9 for operation of a hearing aid by a hearing-impaired person.

12. System for implementing the method per one of the claims 1 to 9, characterized in that a processing unit is provided which receives an input signal and which permits within the processing unit the determination of a threshold value (Oₘₐₓ, Oₘᵢₙ, O_{TR}) for the purpose of limiting the output signal, said threshold value (Oₘₐₓ, Oₘᵢₙ, O_{TR}) being adjustable as a function of the level of the input signal.

13. System as in claim 12, characterized in that from the level of the input signal a mean level (I) can be determined by averaging, preferably derived only from the ambient noise contained in the input signal.

14. System as in claim 12 or 13, characterized in that the threshold value (O_{TR}) can be adjusted to a point which by a differential amount (TRₘₐₓ) is above the mean level (I) of the input signal, said differential amount (TRₘₐₓ) preferably being equal to twenty decibels.

15. System as in claim 14, characterized in that the mean level (I) can be derived from the input signal s(t) by employing the following formula:
$$I = \frac{I}{T} \times {\int }_{o}^{T} \vert s ( t ) \vert \times ⅆ t$$
where an averaging function can be performed over a time interval T with a duration of preferably five seconds.

16. System as in one of the claims 12 to 15, characterized in that it permits a maximum threshold value (Oₘₐₓ) to be established.

17. System as in claim 16, characterized in that the maximum threshold value (Oₘₐₓ) can be selected to be equal to the upper comfort level of a hearing-impaired person.

18. System as in one of the claims 12 to 17, characterized in that it permits a minimum threshold value (Oₘᵢₙ) to be established.

19. System as in claim 18, characterized in that the minimum threshold value (Oₘᵢₙ) can be selected to be equal to the mean amplification value for a hearing-impaired person.

20. System as in one of the claims 13 to 19, characterized in that the differential amount (TRₘₐₓ) can be adjusted corresponding to the compression ratio for a hearing-impaired person.
